(19) United States
(12) Patent Application Publication
(10) Pub. No.: US 2012/0267434 A1
(43) Pub. Date: Oct. 25, 2012

(54) BODY IN THE FORM OF A PACKAGING OR OF A MOLDED PART

(75) Inventors: Michael Kohla, Havixbeck (DE); Franziska Lindenhahn, Trier (DE)

(73) Assignee: Nordenia Technologies GmbH, Gronau (DE)

(21) Appl. No.: 13/357,956

(22) Filed: Jan. 25, 2012

(30) Foreign Application Priority Data
Jan. 26, 2011 (EP) 11 152 196.9

(51) Int. Cl. G06K 19/077

(52) U.S. Cl. 235/488

(57) ABSTRACT

A body in the form of a packaging or of a molded part has an outer layer composed of a film, on which a radio-frequency identification (RFID) arrangement is provided. An antenna of the RFID arrangement is printed directly on a layer of the film, wherein an RFID chip of the RFID arrangement is disposed on a support section, and wherein the support section with the RFID chip is set onto the film in the region of the RFID antenna.

### CROSS REFERENCE TO RELATED APPLICATIONS

Applicants claim priority under 35 U.S.C. §119 of European Application No. 11 152 196.9 filed Jan. 26, 2011, the disclosure of which is incorporated by reference.

### BACKGROUND OF THE INVENTION

1. Field of the Invention

The invention relates to a body in the form of a packaging or in the form of a molded part. The body has an outer layer composed of a film and a radio-frequency identification (RFID) arrangement is provided. An antenna of the RFID arrangement is printed directly on a layer of the film, and an RFID chip of the RFID arrangement is disposed on a support section. The support section with the RFID chip is set onto the film in the region of the RFID antenna. The RFID chip is connected with an adaptation network disposed on the support section and is coupled with the antenna in contact-free manner, preferably capacitatively by way of the adaption network.

2. The Prior Art

RFID arrangements comprise an antenna, according to their general structure, and an RFID chip that is generally contacted directly with the antenna. RFID arrangements are used for product identification, similar to the widespread bar codes. RFID arrangements are characterized by great reliability, and particularly easy readability. Aside from the transmission of merely an identification number, fundamentally also larger data sets can be stored in memory and read out. Because RFID arrangements can be read out over a certain distance, and no direct visual contact with the reader has to exist, very simple handling is possible even under disadvantageous conditions.

REID arrangements are usually made available in the form of RFID labels, in practice, whereby these labels are pasted onto a packaging or another object to be identified. Corresponding RFID labels are known from EP 1 892 650 B1, U.S. Pat. No. 6,147,662, as well as US 2006/0038687 A1, whereby a body having the characteristics described initially is formed by pasting such a label onto the object to be identified. In this connection, coupling of RFID antennas and the RFID chip usually takes place by way of direct electrically conductive contacting, whereby the antenna is printed onto the film material of the label using an electrically conductive printing ink. Aside from flexible label films, it is also known to apply the RFID arrangements on a shape-stable support, which is then applied as a whole to the object to be identified.

A contact element for connecting an RFID chip with an antenna is known from DE 20 2006 008 789 01, whereby an electrically conductive structure and an RFID chip connected with this structure are provided on a substrate. Proceeding from this arrangement, it is proposed to couple the electrically conductive structure capacitatively to the antenna. The configuration and placement of the antenna are not described in any further detail.

A self-adhesive RFID label as well as a method for its production are known from WO 2008/055578 A1, whereby the RFID chip can be electrically connected with a coupling antenna, which is disposed on a support material, whereby an RFID antenna and the coupling antenna are positioned relative to one another in such a manner that they are inductively coupled. The self-adhesive RFID label is pasted onto the object to be identified, in usual manner.

A body in the form of a packaging or of a molded part is known from WO 2005/073937 A2. Because contact-free coupling, i.e. capacitative or inductive coupling, is also optionally possible, the RFID antenna can also be disposed on the inside of the packaging. With this arrangement, the antenna is protected from influences from the outside, but it can be damaged by the packaged object, under some circumstances, when the packaging is moved.

### SUMMARY OF THE INVENTION

It is an object of the invention to more reliably affix an RFID arrangement on a body in the form of a packaging or of a molded part.

These and other objects are achieved according to the invention by providing a body in the form of a packaging or of a molded part, wherein the body has an outer layer composed of a film, and an RFID arrangement is provided, wherein an antenna of the RFID arrangement is printed directly on a layer of the film, wherein an RFID chip of the RFID arrangement is disposed on a support section, wherein the support section with the RFID chip is set onto the film in the region of the RFID antenna, wherein the RFID chip is connected with an adaptation network disposed on the support section, and wherein the RFID chip is coupled with the antenna in contact-free manner, preferably capacitatively by way of the adaptation network. The film is laminated in multiple layers, and the antenna is disposed on a layer transition of the film that lies on the inside.

As a result, the RFID antenna is a direct component of the packaging or of the molded part, and does not have to be applied with a correspondingly large label. Only the support section with the RFID chip is applied separately, whereby the support section is usually clearly smaller than the antenna.

According to the invention, the RFID chip is coupled with the antenna in contact-free manner, in other words without direct electrical contact. This coupling can take place inductively, or, particularly preferably, capacitatively. For contact-free, preferably capacitative coupling, an adaptation network can be provided for transmission between the RFID chip and the RFID antenna. Thus, it is particularly provided that the RFID chip is connected with an adaptation network disposed on the support section, in other words is usually contacted directly. The RFID chip is coupled with the antenna, however, in contact-free manner, by way of the adaptation network.

In the case of contact-free coupling of the RFID antenna to the RFID chip, for example by way of the adaptation network, the advantage is obtained that the antenna does not have to be disposed on the surface of the film. Thus, according to the invention, a multi-layer laminated film is made available, in which the antenna is disposed on a layer transition of the film that lies on the inside. The antenna is then optimally protected from mechanical damage. Thus, it is also easily possible to first print the antenna onto a film web before sections of the film are then processed to produce parts of a packaging or of a molded part. A gravure printing process is particularly suitable for printing the antenna onto the film web before such processing. Reliable protection is also guaranteed during such processing operations, which include cutting, folding, and sealing, for example, when the RFID antenna is disposed on the inside. Even during subsequent handling of the body, the antenna cannot be damaged as the result of friction wear or other mechanical influences, if it is disposed to lie on the inside. In this connection, it should be taken into consideration that RFID antennas frequently have delicate conductor track structures, and thus are sensitive to damage to a certain degree. If, for example a conductor track is cut, the usual emission characteristics are lost, whereby the characteristic frequency usually also changes completely.

Within the scope of the invention, the material composition of the film is not restricted further. The only thing that has to be guaranteed is that a layer of the film demonstrates sufficient imprintability. For the production of packagings, composite films composed of polyethylene terephthalate and polyethylene (PET/PE composite) are frequently used. In such composites, a decorative imprint is frequently provided at the layer transition that lies on the inside, on the layer of PET. The decorative imprint is then protected from friction wear, after lamination, with at least one further layer, particularly a layer of polyethylene. The RFID antenna can also be applied on the inside, in the same printing process with a conductive ink. Suitable printing inks are known, for example, from DE 10 2005 007 772 A1 and WO 03/068874 A1. Also with regard to the aging resistance of the printing ink, placement of the RFID antenna on a layer transition of the film that lies on the inside is particularly advantageous. Thus, for example, a printing ink that contains silver can easily be used; such an ink is characterized by good electrical properties, but is sensitive to aging when placed in an exposed location. Accordingly, the configuration of the body according to the invention, with the antenna at a layer transition that lies on the inside, is also suitable for long-term storage or archiving of the objects to be identified. In other words, the configuration is suitable for long-term storage or archiving of the packaging or of the molded part.

A body in the form of a packaging can particularly be formed by means of heat-sealing. Accordingly, according to a preferred embodiment of the invention, the film has a layer that can be heat-sealed. Polyolefins, particularly PE, are particularly suitable as heat-sealable materials.

The RFID chip is coupled with the RFID antenna by way of the adaptation network, in the manner of an LC oscillation circuit. Proceeding from the connectors for the RFID chip, the adaptation network can therefore have conductor tracks and conductive surfaces. The conductor tracks essentially have the function of a coil, and the conductive surfaces essentially have the function of a capacitor. The adaptation network is provided for adaptation of the complex impedances of RFID chip and RFID antenna, so that transmission losses are minimized. If a total resonance is produced as the result of the adaptation by means of the adaptation network, a maximal signal emission or sensitivity of the RFID arrangement is achieved. In the case of the preferred capacitative coupling, it is practical if conductive surfaces assigned to one another are provided on the adaptation network and on the RFID antenna, which surfaces form a capacitor with the material that is disposed in between.

Aside from the size of and the distance between the surfaces, the electricity constant of the material disposed in between also has to be taken into consideration. When the RFID antenna is placed within a multi-layer film, the layers present between the RFID antenna and the adaptation network therefore have to be taken into consideration in terms of their thickness and their dielectricity. Within the scope of the invention, capacitative coupling is advantageous because in this way, signal transmission with minimized transmission losses is possible, with a compact structure. Alternatively, however, it is fundamentally also possible to provide inductive coupling between the adaptation network and the RFID antenna. In this case, conductor tracks or coil structures of adaptation network and RFID antenna that are assigned to one another must be provided.

In the production of the RFID labels known from the state of the art, the RFID antennas are printed on a film web very close to one another, in order to achieve optimal surface area utilization. Individual labels are then punched out of the film web. In contrast, the RFID antenna within the scope of the invention is an integral part of the body as a whole, in the form of a packaging or of a molded part. Accordingly, the RFID antenna also covers only a comparatively small region of the entire film. Typically, the area covered by the outer circumference of the RFID antenna amounts to less than 20%, preferably less than 10%, particularly preferably less than 5% of the total surface area of the film.

Within the scope of the invention, the support section with the RFID chip and preferably also with the adaptation network is applied separately. In this connection, the support section can be configured as an adhesive label that is placed on the packaging or on the molded part subsequently. Contact-free, preferably capacitative coupling by way of the adaptation network also has the advantage that in comparison with direct contacting, a clearly lower application precision is required. Satisfactory results are achieved, within the scope of the invention, in the case of capacitative coupling, even if the RFID chip is offset from the adaptation network by a few millimeters, as compared with an optimal orientation. In the case of direct contacting, in contrast, a precision of tenths or even hundredths of a millimeter is usually required.

If the body according to the invention has the form of a packaging, this packaging can be configured, for example, as a film packaging bag. The film packaging bag can be formed in its entirety, without restriction, from the film imprinted with the RFID antenna, by means of folding and heat-sealing. Furthermore, it is also possible to make multiple film cutouts available and to then join these together to form a packaging bag, whereby at least one of the film sections has the RFID arrangement as described.

According to an alternative embodiment, a deep-drawn packaging is formed, whereby the film provided with the RFID arrangement forms either a deep-drawn depression or a removable lid. In the case of a deep-drawn depression, the imprint of the RFID antenna can also take place before deep-drawing, if the antenna is kept away from greatly deformed regions. The RFID antenna can be disposed at the bottom of the depression, for example.

Within the scope of the invention, the advantage is obtained that the general configuration of the film is not further restricted. In the case of integration of the RFID antenna into the lid of a deep-drawn packaging, the film that forms the lid can also have known barrier layers for aroma protection and/or adhesive layers for allowing a re-closure.

According to another alternative embodiment of the invention, the film provided with the RFID arrangement forms an outer layer of a molded body. The polymer material of the molded body is injection-molded or foamed behind the film. This embodiment can be a part for a motor vehicle, for example.

Another aspect of the present invention relates to the emission characteristics of the RFID antenna. Thus, the RFID antenna has a structure, according to a preferred embodiment of the invention, having two dipole arrangements that intersect, whereby the RFID chip has four connectors for coupling to the antenna. It is possible to achieve uniform emission behavior, particular all-around emission behavior, by means of a suitable antenna geometry with intersecting dipole arrangements. An RFID chip that is particularly suitable in combination with such an RFID antenna is sold by the manufacturer Impinj, Inc., Seattle, Wash. 98103, under the name Monza® 4.

According to a particularly preferred embodiment of the invention, the RFID antenna has four segments configured the same way, which are disposed at an angle division of 90° and extend from a central coupling region toward the outside. The segments are configured with mirror symmetry, in each instance, with regard to a longitudinal segment axis that extends outward from the coupling region. The segments also have at least one free surface, in each instance, along their longitudinal segment axis, which surface is surrounded by conductive material in frame shape.

In particular, the segments can have at least two consecutive free surfaces, in each instance, which are surrounded by conductive material in frame shape, and between which a constriction is provided. Such an antenna geometry with segments having mirror symmetry has no example in the state of the art. According to the state of the art, structures that run in meander shape and are therefore asymmetrical are frequently implemented. The RFID antenna described is characterized by particularly uniform all-around emission characteristics.

### BRIEF DESCRIPTION OF THE DRAWINGS

Other objects and features of the present invention will become apparent from the following detailed description considered in connection with the accompanying drawings. It is to be understood, however, that the drawings are designed for the purpose of illustration only and not as a definition of the limits of the invention.

In the drawings, wherein similar reference characters denote similar elements throughout the several views:

FIG. 1 shows a body in the form of a film packaging bag, which is formed from a film,

FIG. 2 shows a section through the film that forms the film packaging bag, in the region of an RFID arrangement,

FIG. 3 shows the detailed configuration of the RFID arrangement,

FIG. 4 shows a body in the form of a deep-drawn packaging, and

FIG. 5 shows a body in the form of a molded part.

### DETAILED DESCRIPTION OF THE PREFERRED EMBODIMENTS

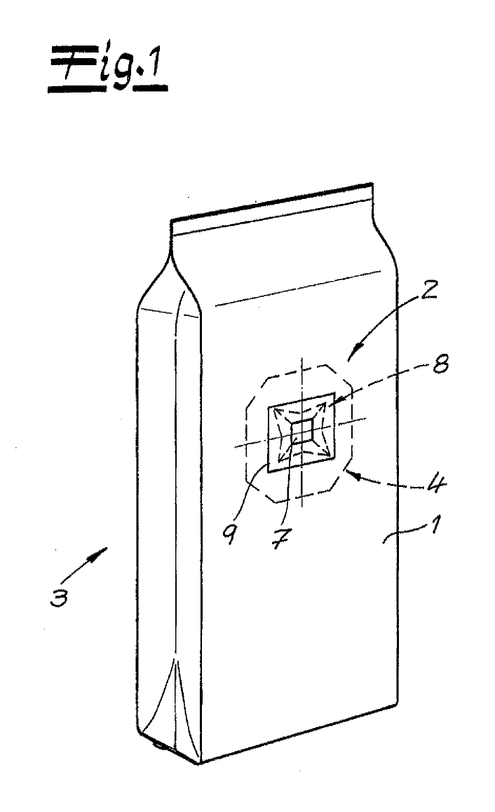

Referring now in detail to the drawings, the invention relates to a body in the form of a packaging such as is shown in FIG. 1 or of a molded part such as is shown in FIG. 5, having an outer layer composed of a film 1, on which an RFID arrangement 2 is provided.

FIG. 1 shows a concrete exemplary embodiment of a packaging bag 3, which is completely formed from the film 1 and has the RFID arrangement 2 as described on a front surface.

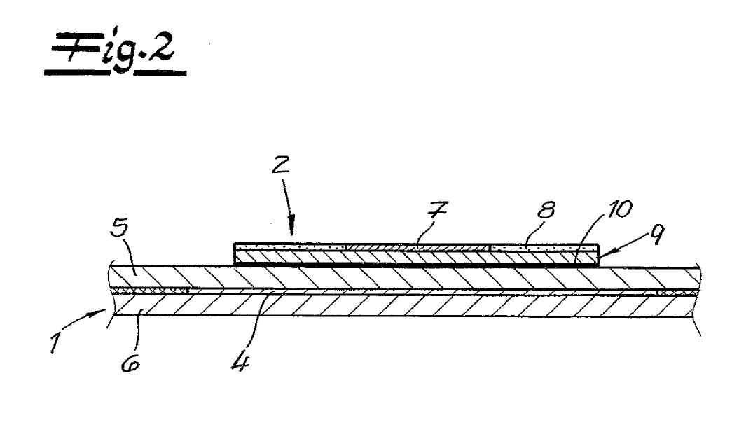

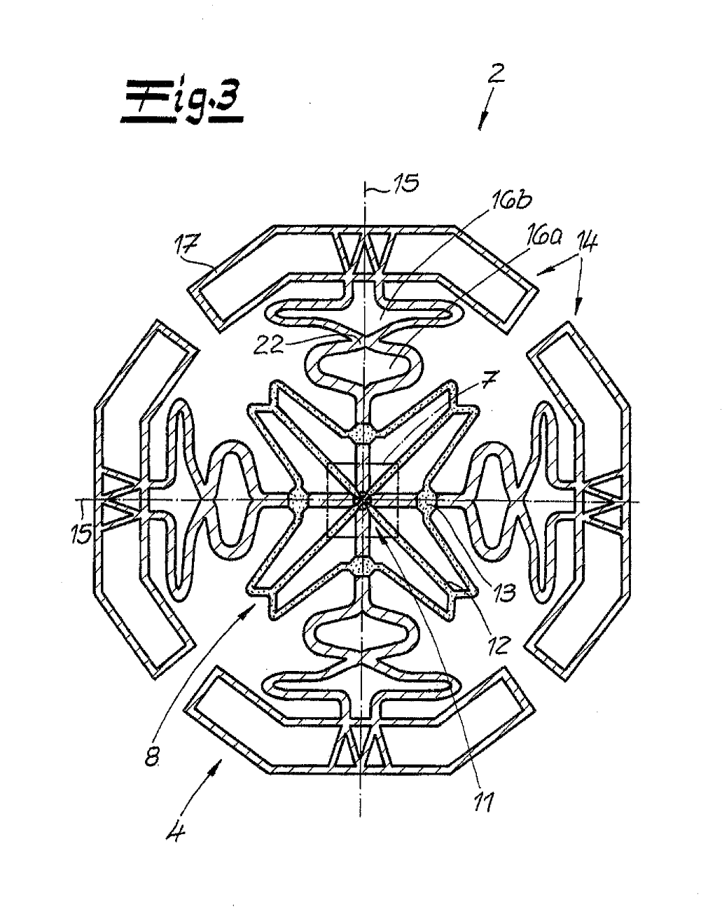

The further configuration of the RFID arrangement 2 can be derived from FIGS. 2 and 3. Thus, FIG. 2 shows that an antenna 4 of the REID arrangement 2 is imprinted directly on a layer of the film 1, using a conductive printing ink. The imprinting can particularly take place in a gravure printing process, whereby aside from the RFID antenna 4, a decorative imprint or a labeling can also be applied, using normal printing ink.

According to the exemplary embodiment of FIG. 2 that represents the preferred embodiment, the RFID antenna 4 is disposed to lie on the inside, at a layer transition of the film, between an outer layer 5 and an inner layer 6. While the inner layer 6 is formed from a material that can be sealed well, for example PE, the outer layer 5 imparts a high-quality appearance to the film packaging bag 3. PET can be provided as the outer layer, for example, whereby then, in the case of such a PET/PE composite, the outer layer 5, which consists of PET, is usually imprinted. Because the RFID antenna 4 is placed to lie on the inside, it is optimally protected from damage. In FIG. 2, it is indicated that aside from the RFID antenna 4, a normal imprint is also present between the outer layer 5 and the inner layer 6.

The RFID arrangement 2 furthermore has an RFID chip 7 and an adaptation network 8. Because the RFID antenna 4 is disposed on the film 1 to lie on the inside, the RFID chip 7 cannot be contacted with the RFID antenna 4 in direct, electrically conductive manner. According to the exemplary embodiment, coupling of the RFID chip 7 with the RFID antenna 4 takes place capacitatively, by way of the adaptation network 8 that is shown in detail in FIG. 2, together with the RFID antenna 4. The RFID chip as well as the adaptation network 8 directly contacted with this chip 7 are applied to the film 1 with a support section 9, in the form of a label film, in the region of the antenna 4, and are attached using an adhesive 10 of the support section 9.

The RFID antenna 4 has the shape of two intersecting dipoles. Accordingly, the adaptation network 8 is also formed with four segments having the same configuration. Proceeding from a central connection region 11, at which the RFID chip merely indicated in FIG. 3 is directly contacted with four connectors, the adaptation network 8 has conductor tracks 12 that at first extend outward and then divide. The conductor tracks 12 of adjacent segments then come together in widened conductive surfaces 13.

The adaptation network 8 as described is configured in the manner of an LC oscillation circuit, in order to bring about an impedance adaptation between RFID chip 7 and REID antenna 4, in such a manner that transmission losses are minimized and the emission and sensitivity of the RFID arrangement 2 are maximized and adapted to the signal frequency of the RFID chip 7 and the RFID antenna 4. The capacitative coupling to the RFID antenna 4 takes place essentially at the conductive surfaces 13, whereby these conductive surfaces 13 represent parts of a capacitor, and the preceding conductor tracks 12 represent the coils that determine the inductivity, in an equivalent circuit diagram.

The RFID antenna 4, separated from the adaptation network 8 by means of the support section 9 in the form of a label film and by means of the outer layer 5, according to FIG. 2, has four segments 14 having the same configuration, according to the exemplary embodiment of FIG. 3. The thickness and the dielectricity of the outer layer 5 and of the support section 9 must be taken into consideration in the coupling between adaptation network 8 and RFID antenna 4.

The segments 14 are disposed in an angle division of 90° and extend outward, proceeding from a central coupling region. The segments 14 are configured with mirror symmetry with regard to a longitudinal segment axis 15 that extends outward from the coupling region, whereby the segments 14 have two consecutive free surfaces 16a, 16b along their longitudinal segment axis 15, in each instance, which surfaces are surrounded by conductive material in frame shape, and between which a constriction 22 is provided. The individual segments 14 have an essentially T-shaped connecting end piece 17, whereby the T-shaped end pieces 17 form a uniform octagonal contour around the circumference.

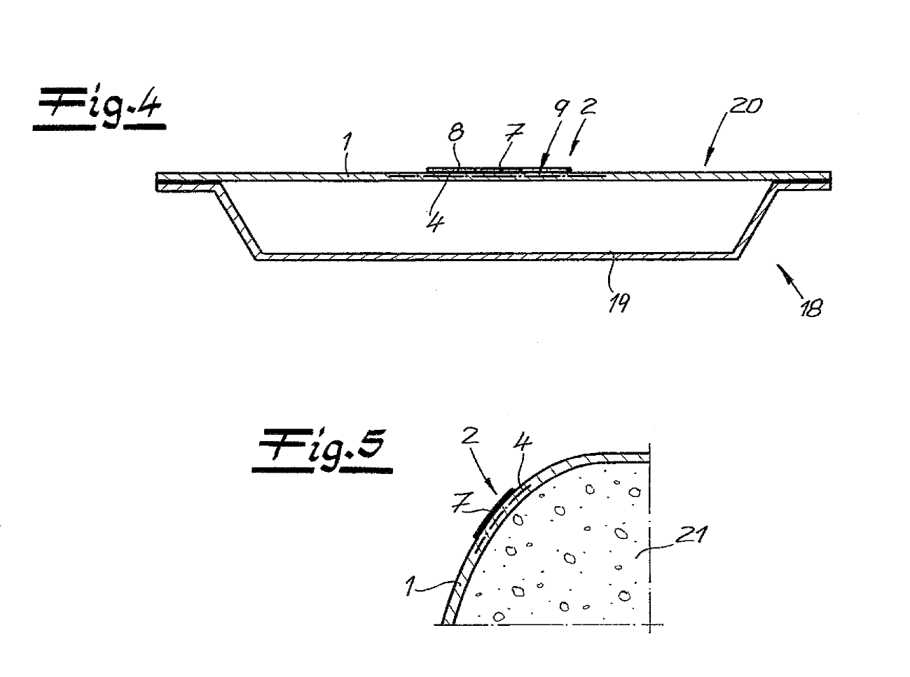

While FIG. 1 shows a body in the form of a packaging bag 3, FIG. 4 shows an alternative embodiment of a packaging in the form of a deep-drawn packaging 18. The deep-drawn packaging 18 has a deep-drawn depression 19 and a lid 20, in usual manner. As an example, the RFID arrangement 2 is provided in the lid, whereby the structure can be configured essentially as described above. Here again, the RFID antenna 4 is imprinted directly onto a layer of the film 1, while the adaptation network 8 and the RFID chip 7 are subsequently applied, using a separate support section 9.

Finally, FIG. 5 shows a molded body, whereby the film 1 forming an outer layer has polymer material 21 injection-molded or foamed behind it. The RFID arrangement 2 is configured as has been described above.

Although only a few embodiments of the present invention have been shown and described, it is to be understood that many changes and modification may be made thereunto without departing from the spirit and scope of the invention.

What is claimed is:

1. A body forming a packaging or a molded part, said body comprising:
(a) a laminated film comprising a plurality of layers;
(b) a support section set onto the laminated film;
(c) a radio-frequency identification arrangement comprising an antenna disposed on a layer transition of the laminated film on an inside portion of the laminated film and a radio-frequency identification chip disposed on the support section near the antenna; and
(d) an adaptation network disposed on the support section and connected with the radio-frequency identification chip;
wherein the radio-frequency identification chip is coupled with the antenna in contact-free manner.

2. The body according to claim 1, wherein the radio-frequency identification chip is coupled with the antenna capacitatively by way of the adaption network.

3. The body according to claim 1, wherein the adaptation network comprises an LC oscillation circuit.

4. The body according to claim 1, wherein the plurality of layers comprises a heat-sealable outside layer.

5. The body according to claim 1, wherein the laminated film has a total surface area and the antenna has an outer circumference covering a surface area of less than 10% of the total surface area of the laminated film.

6. The body according to claim 1, wherein the support section is configured as an adhesive label.

7. The body according to claim 1, wherein the antenna is imprinted with a conductive printing ink using a gravure printing process.

8. A packaging bag comprising
(a) a laminated film comprising a plurality of layers;
(b) a support section set onto the laminated film;
(c) a radio-frequency identification arrangement comprising an antenna disposed on a layer transition of the laminated film on an inside portion of the laminated film and a radio-frequency identification chip disposed on the support section near the antenna; and
(d) an adaptation network disposed on the support section and connected with the radio-frequency identification chip;
wherein the radio-frequency identification chip is coupled with the antenna in contact-free manner.

9. A deep-drawn packaging comprising:
(a) a laminated film comprising a plurality of layers, said laminated film forming a deep-drawn depression or a removable lid;
(b) a support section set onto the laminated film;
(c) a radio-frequency identification arrangement comprising an antenna disposed on a layer transition of the laminated film on an inside portion of the laminated film and a radio-frequency identification chip disposed on the support section near the antenna; and
(d) an adaptation network disposed on the support section and connected with the radio-frequency identification chip;
wherein the radio-frequency identification chip is coupled with the antenna in contact-free manner.

10. A molded body comprising
(a) a laminated film comprising a plurality of layers;
(b) polymeric material injection-molded or foamed behind the laminated film;
(c) a support section set onto the laminated film;
(d) a radio-frequency identification arrangement comprising an antenna disposed on a layer transition of the laminated film on an inside portion of the laminated film and a radio-frequency identification chip disposed on the support section near the antenna; and
(e) an adaptation network disposed on the support section and connected with the radio-frequency identification chip;
wherein the radio-frequency identification chip is coupled with the antenna in contact-free manner.

11. The body according to claim 1, wherein the antenna has a structure with two intersecting dipole arrangements, wherein the radio-frequency identification chip has four connectors for coupling to the antenna.

12. The body according to claim 1, wherein the radio-frequency identified antenna has four identically-configured segments disposed at an angle division of 90° and extending outwardly from a central coupling region, wherein each segment is configured with mirror symmetry with regard to a longitudinal segment axis extending outwardly from the central coupling region, and wherein each segment has at least one free surface along the longitudinal segment axis surrounded by a frame of conductive material.

13. The body according to claim 12, wherein each segment has at least two consecutive free surfaces surrounded by the frame of conductive material and wherein a constriction is provided between the at least two consecutive free surfaces.
